(19) United States
(12) Patent Application Publication
(10) Pub. No.: US 2007/0150279 A1
(43) Pub. Date: Jun. 28, 2007

(54) Word matching with context sensitive character to sound correlating

(75) Inventors: Rikin Gandhi, Foster City, CA (US); Ciya Liao, Mountain View, CA (US)

Correspondence Address: MCDONALD HOPKINS CO., LPA, 600 SUPERIOR AVE., E., SUITE 2100, CLEVELAND, OH, 44114, US

(73) Assignee: Oracle International Corporation, Redwood Shores, CA (US)

(21) Appl. No.: 11/318,826

(22) Filed: Dec. 27, 2005

(51) Int. Cl. G10L 13/00

(52) U.S. Cl. 704/258

(57) ABSTRACT

Systems, methods, media, and other embodiments associated with word matching with context sensitive character to sound correlating are described. One exemplary method embodiment includes automatically generating context sensitive character to sound correlation rules, making the rules available to a query processing logic, converting words into sets of sounds using the rules, and storing a data entry linking the word and set of sounds in a data store searchable by the query processing logic.

### BACKGROUND

There are two categories of conventional word matching algorithms, phonetic matching algorithms and pattern matching algorithms. Phonetic matching algorithms focus on words (e.g., names) that sound alike (e.g., Shuin, Chwynne) regardless of spelling. Traditional phonetic matching algorithms may map words to compressed code representations and/or may use pre-defined heuristic pronunciation rules to convert a word into a phoneme-based code representation. Pattern matching algorithms focus on words that are spelled similarly (e.g., McDonald, MacDonald). Pattern matching algorithms may focus on character and word variants and thus may identify letter distributions, punctuation, and so on using measures like edit distance that determine the number of operations required to permute one word into another.

Both of these types of conventional word matching algorithms may yield sub-optimal performance due to issues attributable to cultural, linguistic, human-machine interface, querying, and indexing causes. For example, cultural variations between a person who stores a word in a database, a person who queries for the word, a person who creates an index in a database, and the person using the word may lead to misspellings that complicate matching. The different cultures may have different spelling rules, name ordering rules, pronunciation rules, alphabets, naming systems, and so on. Additionally, even in culturally aware systems, tense rules, gender rules, stress rules, and so on that apply to regular words may not apply to proper names, making names particularly difficult to match.

Additional issues are based on the source of words to be matched found in a database. The sources may include manual transcriptions of written text, manual transcriptions of speech, automatic name recognition systems, speech recognition systems, and so on. These different sources may produce words for the database using different approaches that lead to different spellings and/or soundings. Thus, selecting from a database table a word(s) that matches a word in a query is a complicated task. Manual errors like simple typing mistakes may even further exacerbate the difficulty of the task.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries and that elements may not be drawn to scale. One of ordinary skill in the art will appreciate that unless otherwise stated one element may be designed as multiple elements, multiple elements may be designed as one element, an element shown as an internal component of another element may be implemented as an external component and vice versa, and so on.

FIG. 1 illustrates an example method associated with word matching.

FIG. 2 illustrates an example method associated with word matching.

FIG. 3 illustrates an example system associated with word matching.

FIG. 4 illustrates an example system associated with word matching.

FIG. 5 illustrates an example computing environment in which example systems and methods illustrated herein may operate.

FIG. 6 illustrates an example application programming interface (API).

### DETAILED DESCRIPTION

This application describes example sound based word matching systems and methods. Example systems and methods may match words (e.g., names) after performing context sensitive character to sound correlating to form “sounded out” words. The example systems and methods blend speech synthesis technology with machine learning technology to construct context sensitive letter to sound rules that may be trained up using culturally aware pronunciation dictionaries. The context sensitive letter to sound rules facilitate producing phonetic representations that can be matched in a substantially universal manner. “Context free” matching will be used to refer to this matching of substantially universal phonetic representations that are decoupled, at least in part, from the input characters. Thus, the sounds produced by context sensitive rules can be used in a context free way to match a word in a query to a word(s) in a data store (e.g., relational database table) by sound. The returned word(s) may have an associated confidence level that describes the degree to which the example systems and methods correlated the query word with the retrieved word.

Example matching systems and methods may favor recall over precision based on an expectation that matching relevancy is based on sound similarity. This expectation is predicated on the assumption that a user that does not know the exact spelling of a particular word may “sound it out” and select a sequence of characters that provide a similar sounding representation of the word. How a word is sounded out may depend on linguistic characteristics of the user (e.g., first language spoken, literacy, foreign languages spoken, geographic region). The representation may then be converted to sounds using the context sensitive rules. The sounds may be, for example, substantially universal phonetic representations that are context free. An individual letter (e.g., t) or a small group of letters (e.g., th) may account for a single sound. A set of letters (e.g., Theseus) may account for a set of related sounds representing a word. Thus, example systems and methods may use machine learned rules to produce sets of sounds that are used to match against stored sets of sounds.

Conventional speech synthesis systems may rely on text-to-phoneme converters that build grapheme-to-phoneme rules in the form of decision trees. The speech synthesis systems may use pronunciation dictionaries as inputs when building the decision trees of rules. The rules may be made by taking words in a pronunciation dictionary together and finding a rule(s) that makes a good initial predictive split of the data. The approach may then be repeated on the resulting splits until a tree of decisions is created. While splitting and a decision tree are described it is to be appreciated that in some examples other machine-learning techniques and data structures may be employed.

Text-to-phoneme conversion may rely on alignment. Given a set of words and their pronunciations, a set of alignments between the letters and phonemes may be produced. Thus, letters may be matched with phonemes and a mapping may be made between ordered lists of letters and phonemes. Generating good alignments is a complicated task and may traditionally have been performed using techniques like a learning method, a neural network, and so on. In some cases, these alignments may be expanded into feature vectors for letters. The feature vectors facilitate providing some context for a letter. For example, a letter may be viewed in the context of previous and/or following letters. Feature vectors may therefore facilitate unwrapping context sensitive grammars and providing rewrite rules. The context sensitive grammar and rewrite rules taken together facilitate building a decision tree based on features. The decision tree may facilitate producing an output phoneme.

The resulting decision trees are similar in some ways to data structures employed in heuristic, phonetic-based name matching techniques. However, data structures used in phonetic-based name matching may be fixed and based on expert intuition concerning the context sensitive relationship of letters to phonemes for a language. Here, example systems and methods employ machine learning to automatically derive correlations from a pronunciation dictionary. The correlations may then be used in sound based matching.

In one example, a machine learning logic (e.g., Support Vector Machine (SVM)) may facilitate learning context sensitive mappings of letters to phonemes from pronunciation dictionaries. The machine learning logic may facilitate supervised classification for learning classification rules by training on a set of pre-classified samples. The context sensitive mappings may be represented in a feature vector of grams. In one example, a user may specify a maximum gram size for letters in a word. Uni-grams of this size may then be created. By way of illustration, consider the word “jack” with a specified maximum gram size of three. This could lead to the following grams and sound mappings:

| Letter | Grams | Sound |
|---|---|---|
| j | J JA JAC | JH |
| a | A JA AC JAC ACK | AE |
| c | C AC CK JAC ACK | K |
| k | K CK ACK | — |

The machine learning logic may provide a procedure for generating query rules to categorize user samples supplied as a training set of pre-classified samples. The procedure may generate queries that define categories and write the results to a table. One classifier (e.g., SVM_CLASSIFIER) may use an SVM algorithm to produce opaque binary rules.

In one example, systems and methods may perform context sensitive sound classification for individual characters in a word. Therefore, separate training tables may be created for individual characters in a training set. These character-specific tables may include a word, grams for the character, and the sound associated with the character. A character specific training table relates (maps) grams to sounds. The grams in a particular character specific table may come from words in a pronunciation dictionary that contain the character that is the subject of the character specific training table. Continuing the example above, the name “jack” may produce individual rows in ‘j’, ‘a’, ‘c’, and ‘k’ tables. Words that include multiple instances of the same character may produce a corresponding multiple of rows in the training table for that character.

In one example, an existing document classifier may be modified to perform sound classification instead of document classification by adjusting definitions and inputs for the existing classifier. For example, “documents” typically classified by the classifer (e.g., SVM_CLASSIFIER) can be replaced with “words”, document categories can be reworked to represent the sound of the particular character, and document tokens may be replaced by grams for a character.

The classifier may then create binary rules for character-specific training tables using pre-classified character gram to sound mappings. A string of grams associated with a word may then be used in a query to obtain possible sounds and related confidences based on a context associated with a word. Then, for matching, combinations of possible sounds for a character may be matched against an existing table of words and sounds. Combinations may be evaluated using, for example, a query language (e.g., SQL) SELECT statement operator (e.g., equal).

The number of sound combinations may quickly expand as the number of characters in a word increases. Thus, in different examples, mechanisms may be provided to limit the number of evaluated combinations. For example, a maximum number of highest confidence sounds considered for a character may be established, a minimum confidence for a combination of characters' sounds may be established, and so on. The confidence for a word may be computed from the confidence for member letters in a word. Thus, in one example, matching may include both an orthographic portion and a phonetic portion. In the orthographic portion, the edit distance between two items being compared may be computed. This edit distance may describe, for example, the number of operations that would be required to transform a query word into a table word. In the phonetic portion, a linguistic variant of edit distance between two items being compared may be computed. This phonetic edit distance may describe, for example, the number of operations that would be required to transform a sound generated from a query word to a stored sound associated with a table word. The results from the orthographic and phonetic based portions may then be combined to score and rank matches.

How a search for matching words in a database proceeds may be influenced by the form of the indexes and queries employed in the search. Thus, in different examples users may be able to configure indexes for use with the matching systems and methods. For example, a user may be allowed to select a field(s) that includes data to index, to assign a confidence weighting on a field(s), to set a confidence score for possible field orderings, to determine phonetic sound representations of a word based on pronunciation training data, to store combinations of words and sounds, to store grams of combinations of words and sounds in inverted indexes for inexact matching, to store base table names in an index, to store additional meta-data, and so on.

Similarly, in different examples, users may be able to manipulate a query for use with matching systems and methods. For example, a user may be allowed to tune a result set by adjusting threshold and discount factor parameters, to select a maximum number of results, to select a minimum overall confidence threshold, to adjust weightings, to adjust confidence thresholds, to assign confidence weightings to fielded query terms, to establish region parameter(s) to use for region-specific pronunciation rewrite rules, and so on.

Thus, example systems and methods may provide querying users with ranked matches that satisfy expectations by favoring recall over precision and by handling common sources of word matching errors. The example systems and methods employ machine learning to learn context sensitive character to sound correlations associated with a particular culture. This facilitates producing sounds that can then be used in matching words in a database and query terms in a largely universal (e.g., culturally context free) sound based manner.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer component”, as used herein, refers to a computer-related entity (e.g., hardware, firmware, software, software in execution, combinations thereof). Computer components may include, for example, a process running on a processor, a processor, an object, an executable, a thread of execution, a program, and a computer. A computer component(s) may reside within a process and/or thread. A computer component may be localized on one computer and/or may be distributed between multiple computers.

“Computer communication”, as used herein, refers to a communication between computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer-readable medium”, as used herein, refers to a medium that participates in directly or indirectly providing signals, instructions and/or data that can be read by a computer. A computer-readable medium may take forms, including, but not limited to, non-volatile media (e.g., optical disk, magnetic disk), volatile media (e.g., semiconductor memory, dynamic memory), and transmission media (e.g., coaxial cable, copper wire, fiber optic cable, electromagnetic radiation). Common forms of computer-readable mediums include floppy disks, hard disks, magnetic tapes, CD-ROMs, RAMs, ROMs, carrier waves/pulses, and so on. Signals used to propagate instructions or other software over a network, like the Internet, can be considered a “computer-readable medium.”

In some examples, “database” is used to refer to a table. In other examples, “database” may be used to refer to a set of tables. In still other examples, “database” may refer to a set of data stores and methods for accessing and/or manipulating those data stores.

“Data store”, as used herein, refers to a physical and/or logical entity that can store data. A data store may be, for example, a database, a table, a file, a list, a queue, a heap, a memory, a register, and so on. In different examples a data store may reside in one logical and/or physical entity and/or may be distributed between multiple logical and/or physical entities.

“Logic”, as used herein, includes but is not limited to hardware, firmware, software and/or combinations thereof to perform a function(s) or an action(s), and/or to cause a function or action from another logic, method, and/or system. Logic may include a software controlled microprocessor, discrete logic (e.g., application specific integrated circuit (ASIC)), an analog circuit, a digital circuit, a programmed logic device, a memory device containing instructions, and so on. Logic may include a gate(s), a combinations of gates, other circuit components, and so on. In some examples, logic may be fully embodied as software. Where multiple logical logics are described, it may be possible in some examples to incorporate the multiple logical logics into one physical logic. Similarly, where a single logical logic is described, it may be possible in some examples to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Precision” as used herein refers to a ratio of retrieved relevant items to a number of retrieved items.

“Query”, as used herein, refers to a semantic construction that facilitates gathering and processing information. A query may be formulated in a database query language like structured query language (SQL) or object query language (OQL). A query may be implemented in computer code (e.g., C#, C++, Javascript) for gathering information from various data stores and/or information sources.

“Recall” as used herein refers to a ratio of retrieved relevant items to a number of relevant items available.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more computer instructions and/or processor instructions that can be read, interpreted, compiled, and/or executed by a computer and/or processor. Software causes a computer, processor, or other electronic device to perform functions, actions and/or behave in a desired manner. Software may be embodied in various forms including routines, algorithms, modules, methods, threads, and/or programs. In different examples software may be embodied in separate applications and/or code from dynamically linked libraries. In different examples, software may be implemented in executable and/or loadable forms including, but not limited to, a stand-alone program, an object, a function (local and/or remote), a servelet, an applet, instructions stored in a memory, part of an operating system, and so on. In different examples, computer-readable and/or executable instructions may be located in one logic and/or distributed between multiple communicating, co-operating, and/or parallel processing logics and thus may be loaded and/or executed in serial, parallel, massively parallel and other manners.

Suitable software for implementing various components of example systems and methods described herein may be developed using programming languages and tools (e.g., Java, C, C#, C++, C, SQL, APIs, SDKs, assembler). Software, whether an entire system or a component of a system, may be embodied as an article of manufacture and maintained or provided as part of a computer-readable medium. Software may include signals that transmit program code to a recipient over a network or other communication medium.

“User”, as used herein, includes but is not limited to, one or more persons, software, computers or other devices, or combinations of these.

Some portions of the detailed descriptions that follow are presented in terms of algorithm descriptions and representations of operations on electrical and/or magnetic signals capable of being stored, transferred, combined, compared, and otherwise manipulated in hardware, which are used by those skilled in the art to convey the substance of their work to others. An algorithm is here, and generally, conceived to be a sequence of operations that produce a result. The operations may include physical manipulations of physical quantities. The manipulations may produce a transitory physical change like that in an electromagnetic transmission signal.

It has proven convenient at times, principally for reasons of common usage, to refer to these electrical and/or magnetic signals as bits, values, elements, symbols, characters, terms, numbers, and so on. These and similar terms are associated with appropriate physical quantities and are merely convenient labels applied to these quantities. Unless specifically stated otherwise, it is appreciated that throughout the description, terms including processing, computing, calculating, determining, displaying, automatically performing an action, and so on, refer to actions and processes of a computer system, logic, processor, or similar electronic device that manipulates and transforms data represented as physical (electric, electronic, magnetic) quantities.

Example methods may be better appreciated with reference to flow diagrams. While for purposes of simplicity of explanation, the illustrated methods are shown and described as a series of blocks, it is to be appreciated that the methods are not limited by the order of the blocks, as some blocks can occur in different orders and/or concurrently with other blocks from that shown and described. Moreover, less than all the illustrated blocks may be required to implement an example method. In some examples, blocks may be combined, separated into multiple components, may employ additional, not illustrated blocks, and so on. In some examples, blocks may be implemented in logic. In other examples, processing blocks may represent functions and/or actions performed by functionally equivalent circuits (e.g., an analog circuit, a digital signal processor circuit, an application specific integrated circuit (ASIC)), or other logic device. Blocks may represent executable instructions that cause a computer, processor, and/or logic device to respond, to perform an action(s), to change states, and/or to make decisions. While the figures illustrate various actions occurring in serial, it is to be appreciated that in some examples various actions could occur concurrently, substantially in parallel, and/or at substantially different points in time.

It will be appreciated that electronic and software applications may involve dynamic and flexible processes and thus that illustrated blocks can be performed in other sequences different than the one shown and/or blocks may be combined or separated into multiple components. In some examples, blocks may be performed concurrently, substantially in parallel, and/or at substantially different points in time.

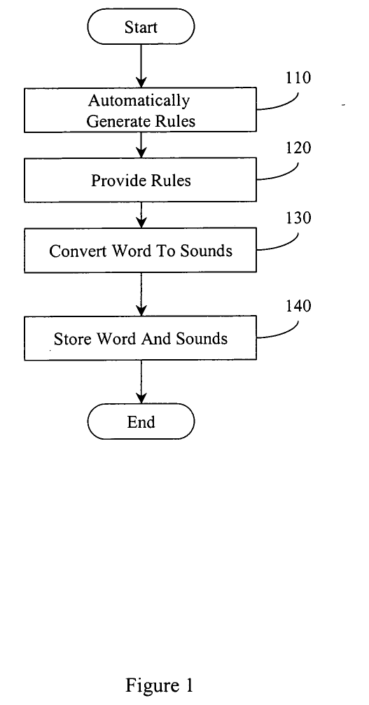

FIG. 1 illustrates a method 100. Method 100 may include, at 110, automatically generating context sensitive character to sound correlation rules. The context to which the rules are sensitive may concern, for example, cultural and/or linguistic matters that determine, at least in part, how words are spelled and spoken, how the spoken word relates to the written word, and so on. In one example, the rules may be configured to favor recall over precision.

In different examples automatically generating rules may include supervised and/or unsupervised machine learning. When machine learning, the rules may be trained up using a culturally aware pronunciation dictionary. The culturally aware pronunciation dictionary may include, for example, words having characters described in a phonetically characterized training set of characters. This phonetically characterized training set of characters may have been created beforehand by, for example, a linguistic expert. In some examples the dictionary may be context sensitive at the language level (e.g., English, French) while in other examples the dictionary may be context sensitive to attributes including region (e.g., North America, Africa, Indo-China), location (e.g., Paris French, Lyon French), culture (e.g., Canadian French, Belgian French, Congo French, France French), literacy, purpose, and so on.

In one example, automatically generating the rules may include creating a character specific training table for a character in the training set of characters. This character specific training table may include words in which the character is found, grams related to the character, sounds associated with the character, and so on. Since a character may have different sounds and may appear in different words, the character specific training table may include multiple entries containing related words, grams, sounds, and so on. While a training table is described, it is to be appreciated that in some examples other data structures (e.g., linked lists, trees, stacks, heaps, flat files) may be employed.

In one example, automatically generating the rules may include controlling a text-to-phoneme conversion logic to build grapheme-to-phoneme rules. The text-to-phoneme conversion logic may be, for example, an ASIC, a circuit, a process running on a computer, and so on. The rules may be organized, for example, into decision trees. While decision trees are described, it is to be appreciated that the rules may be organized in other ways (e.g., b-tree, ordered list). The text-to-phoneme conversion logic may, for example, accept input from pre-configured pronunciation dictionaries. In one example, the text-to-phoneme conversion logic may use an alignment based approach where letters are matched with phonemes and a mapping is made between ordered lists of letters and phonemes.

Method 100 may also include, at 120, providing the rules to a query processing logic. The query processing logic may be, for example, an ASIC, a process running on a processor, a special purpose linguistic computer, and so on. Providing the rules may include, for example, storing the rules in a data store, storing the rules in a database, burning a chip to implement the rules, configuring a circuit, and so on.

In one example, the rules may be created by and/or implemented in a modified document classifier. Thus, method 100 may also include modifying an existing document classifying logic to automatically generate the rules. Modifying the logic may include, for example, redefining the inputs and outputs of the logic. For example, redefining may include replacing a document classification definition used by the existing document classifying logic with a word classification definition, replacing a document category with a sound that represents a character, and replacing a document token with a gram for a character.

Method 100 may also include, at 130, converting a word into a first set of sounds using the rules generated at 110. For example, a word may be received from a set of training words. The word may be “sounded out” using text to sound conversion rules. The sounded out word may be accepted and/or manipulated during machine based generation of a sound dictionary. It may be desired to retain this sounded out word and other sounded out words to create a sound based “dictionary” of sounded out words. These sounded out words may then be available for matching in a substantially context free manner based on comparing sounds.

Method 100 may also include, at 140, storing the word and set of sounds in a data store searchable by the query processing logic. Storing the word and set of sounds may include, for example, creating and storing a database record, creating and storing a table entry, creating and storing a data entry in a file, and so on. In one example, storing a word and sounds related to that word may include an index that facilitates searching for a stored word(s) and/or a stored sound(s).

While FIG. 1 illustrates various actions occurring in serial, it is to be appreciated that various actions illustrated in FIG. 1 could occur substantially in parallel. By way of illustration, a first process could automatically generate rules, a second process could provide the rules to a query processing logic, a third process could convert words to sounds, and a fourth process could store words and sounds to be matched against later. While four processes are described, it is to be appreciated that a greater and/or lesser number of processes could be employed and that lightweight processes, regular processes, threads, and other approaches could be employed.

In one example, a method is implemented as processor executable instructions and/or operations stored on a computer-readable medium. The computer-readable medium may store processor executable instructions operable to perform a method that includes automatically generating context sensitive character to sound correlation rules, providing the rules to a query processing logic, converting a word into a set of sounds using the rules, and storing the word and set of sounds in a data store that is searchable by the query processing logic. While the above method is described being stored on a computer-readable medium, it is to be appreciated that other example methods described herein may also be stored on a computer-readable medium.

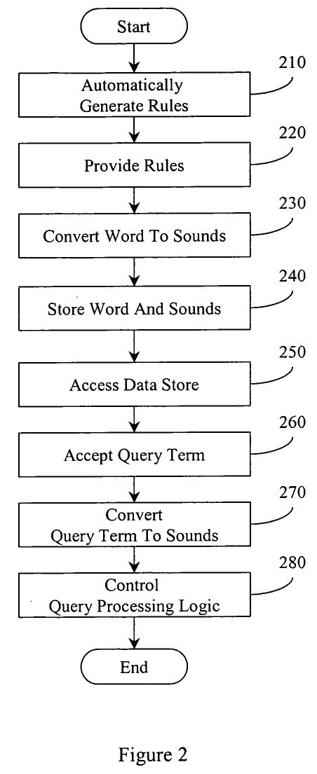

FIG. 2 illustrates a method 200 that includes some elements similar to those found in method 100 (FIG. 1). For example, method 200 includes automatically generating rules 210, providing rules 220, converting words to sounds 230, and storing words and sounds 240. Additionally, method 200 includes, at 250, accessing the data store to facilitate matching sounds produced by converting a query term to sounds stored in the data store. Accessing the data store may include, for example, making a network connection, opening a file, establishing communications between a database and a query processor, and so on.

Since method 200 will match sounds, method 200 also includes, at 260, accepting a query term to match on pronunciation. The query term may be a word and in some cases may be a proper noun (e.g., name). Once again, since method 200 will match on sounds, method 200 may include, at 270, converting the query term into a set of sounds using the automatically generated rules that were provided to the query processing logic. In one example the set of sounds may be a single collection of sounds representing one possible “sounded out” example of the query term while in another example the set of sounds may be a set of sounded out examples of the query term. These are the sounds that will be matched against the sounded out words stored and available to the query processing logic.

Therefore method 200 may include controlling the query processing logic to select a word(s) from the data store based, at least in part, on matching the sounds associated with the query term to sounds stored and available to the query processing logic. Since the matching is sound based method 200 may include controlling the query processing logic to input a string of grams associated with the query term. This string of grams can be compared to stored grams and thus the query processing logic may return sounds (e.g., sounded out words) and confidences related to the sounds. An overall confidence for a word may be computed, for example, by summing individual confidences for individual letters in a word. In one example, the sum may be weighted towards sounds having higher confidence levels. Since the method may be configured to favor recall over precision, words having an overall confidence above a pre-determined, configurable threshold may be presented to a user as “matching” the query term even though the are not an exact match. The number of words presented may be controlled, for example, by manipulating the threshold.

The query processing logic may be user configurable which in turn may make matching controlled by method 200 configurable. Method 200 may therefore include accepting a user input to configure the method and/or query processing logic. For example, user inputs concerning a maximum number of highest confidence sounds considered for a character and a minimum confidence for a combination of character sounds may be received.

Method 200 may control the query processing logic to search a database. Database performance may depend on index selection and/or configuration. Thus, method 200 may also include accepting a user input to configure and/or manipulate an index for use by the query processing logic. This user input may concern, for example, selecting a field that includes word data to index, assigning a confidence weighting on a field, setting a confidence score for a possible field ordering, determining a phonetic sound representation of a word based on pronunciation training data, storing combinations of words and sounds, storing grams of combinations of words and sounds in inverted indexes, storing base table names, and storing meta-data. It is to be appreciated that in some examples other user inputs may be accepted to configure other index attributes.

Method 200 may provide data to the query processing logic in the form of a query. Thus, method 200 may also include accepting a user input configured to manipulate and/or configure a query. This input may concern, for example, setting a threshold and discount factor, selecting a maximum number of results, selecting a minimum overall confidence threshold, adjusting weightings like an orthographic similarity weighting or a phonetic similarity weighting, adjusting thresholds like an orthographic similarity confidence threshold or a phonetic similarity confidence threshold, assigning confidence weightings to fielded query terms, establishing a region parameter associated with a region-specific pronunciation rewrite rule, and so on. It is to be appreciated that in some examples other user inputs may be accepted to configure other query attributes.

Thus, method 200 facilitates accepting inputs from different sources and performing sound based comparisons. Consider a situation where two people may write and speak the same word differently. For example, a first person (e.g., American) may write and pronounce “flavor” in one way while a second person (e.g., Canadian) may write and pronounce “flavour” in a second way. This occurs even between cultures having numerous linguistic similarities (e.g., American, Canadian). In one example, the first “flavor” would be converted using a first culturally aware sound dictionary and rules. The second “flavour” would also be converted but using a second culturally aware sound dictionary and rules. Then, the two converted sets of sounds can be compared in a substantially universal (e.g., context free) manner independent of complications due to spelling and/or typing issues.

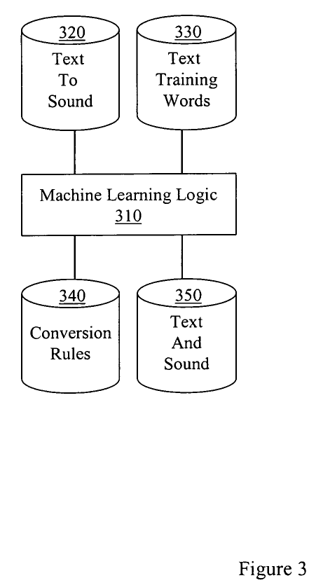

FIG. 3 illustrates a system 300 that includes a machine learning logic 310. Different machine learning approaches known to those skilled in the art may be employed. Thus, in one example machine learning logic 310 may be trained up while being supervised while in another example machine learning logic 310 may be trained up in an unsupervised mode. Machine learning logic 310 may accept text (e.g., letter) to sound (e.g., phoneme) data from a data store 320. This data may have been crafted by an expert (e.g., linguist). Machine learning logic 310 may also receive text based words upon which it will be trained. The words may form a comprehensive set of words in a language of interest, may form a specialized set of words of interest to a particular person and/or application, and so on. By applying the text to sound data to the text training words, machine learning logic 310 may produce both text to sound conversion rules and text to sound pronunciation data entries. The text to sound conversion rules may be stored in a data store 340 and the text and sound entries may be stored in a data store 350. While four separate data stores are illustrated in FIG. 3, it is to be appreciated that a greater and/or lesser number of data stores could be used to store the inputs and outputs. In one example, the data store(s) may be configured as a table(s) in a relational database.

Machine learning logic 310 may be configured to automatically generate text to sound conversion rules from text to sound pronunciation data entries and the text training words. Machine learning logic 310 may also be configured to store these text to sound conversion rules. Storing the rules may include, for example, burning a chip, configuring a circuit, updating a data structure, updating a database table, and so on. Machine learning logic 310 may be configured to automatically generate text and sound representation data entries and to store the entries. Storing the entries may include, for example, updating a file, updating a database table, burning a chip, configuring a circuit, and so on.

In one example, the text to sound pronunciation data may be provided as a list of letters and phonemes, an ordered list of letters and phonemes, a set of letter/phoneme pairs, and so on. In one example, the text to sound conversion rules may be alignment based grapheme to phoneme rules. These rules may be organized in data structures including a decision tree, a b-tree, a linked list, a file, and so on. Since a stored sound may be generated from several letters, a text and sound representation data entry may include a context providing feature vector for a letter in the word from which the sound was generated. This feature vector may facilitate determining a confidence level for a match, may facilitate selecting one sound from a set of possible sounds for a letter, and so on.

In addition to creating the feature vector, the machine learning logic 310 may be configured to create character specific training tables for characters in the text training words. These character specific training tables may store data including words in which a character is found, grams for a character, sounds associated with a character, and so on.

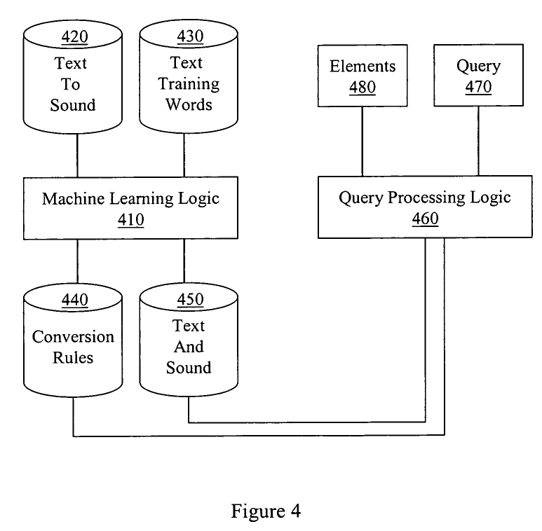

FIG. 4 illustrates a system 400. System 400 includes some elements similar to those found in system 300 (FIG. 3). For example, system 400 includes a machine learning logic 410, a text to sound data store 420, a text training words data store 430, a conversion rules data store 440, and a text and sound data store 450. Once again, while multiple data stores are illustrated it is to be appreciated that the data stored in these data stores may be stored in a greater and/or lesser number of data stores. System 400 may also include a query processing logic 460.

Query processing logic 460 may be configured to receive a textual representation of a word and to produce a sound representation of the word using text to sound conversion rules. The textual representation of the word may be received, for example, in a query 470. The query processing logic 460 may also be configured to provide elements 480 (e.g., matched words) of text and sound representation data entries. The elements 480 may be provided based, at least in part, on matching sounds associated with the query term to data stored in the text and sound representation data store 450.

Since the query processing logic 460 may access an indexed set of data to perform the matching, the query processing logic 460 may include an index manipulation logic. This index manipulation logic may be configured to facilitate selecting a field that includes word data to index. Additionally, and/or alternatively, the index manipulation logic may be configured to facilitate assigning a confidence weighting on a field, setting a confidence score for a possible field ordering, determining a phonetic sound representation of a word based on pronunciation training data, storing combinations of words and sounds, storing grams of combinations of words and sounds in inverted indexes, storing base table names, storing meta-data, and so on.

Since the query processing logic 460 may receive a query 470, the query processing logic 460 may also include a query manipulation logic. The query manipulation logic may be configured to manipulate a query 470 by, for example, selecting a maximum number of results to be returned in response to a query, selecting a minimum overall confidence threshold for results to be returned in response to a query, adjusting various matching weightings (e.g., orthographic similarity, phonetic similarity), adjusting various confidence thresholds (e.g., orthographic edit distance, phonetic edit distance), assigning confidence weightings to query terms, and so on.

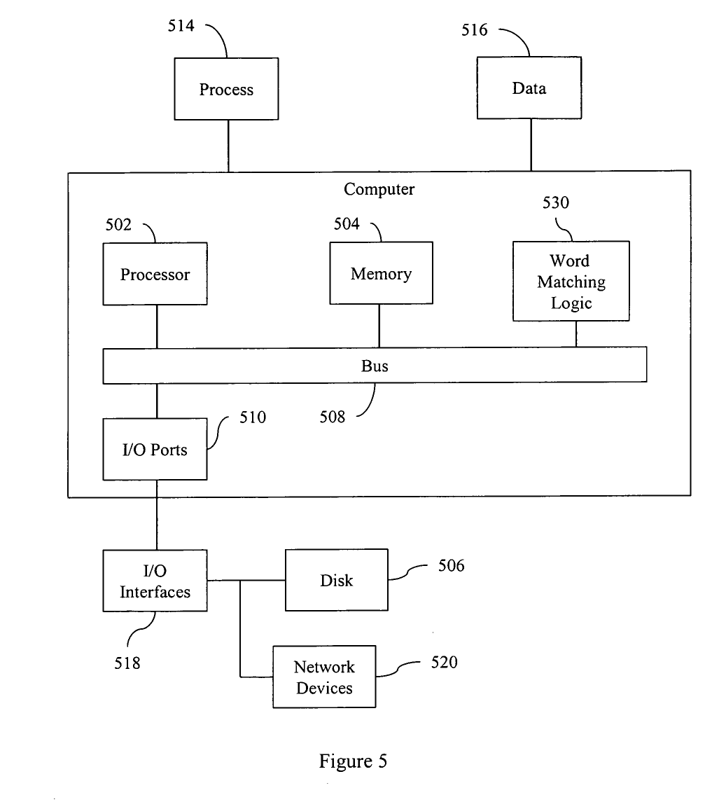

FIG. 5 illustrates an example computing device in which example systems and methods described herein, and equivalents, may operate. The example computing device may be a computer 500 that includes a processor 502, a memory 504, and input/output ports 510 operably connected by a bus 508. In one example, computer 500 may include a word matching logic 530 configured to facilitate word matching with context sensitive character to sound correlating. In different examples, logic 530 may be implemented in hardware, software, firmware, and/or combinations thereof. Thus, logic 530 may provide means (e.g., hardware, software, firmware) for computing a control data for selectively controlling a text to sound conversion logic, means (e.g., hardware, software, firmware) for computing a set of sounds from a set of text, and means (e.g., hardware, software, firmware) for matching a first set of sounds to a second set of sounds where the first set of sounds are computed from a first set of text and the second set of sounds are computed from a second set of text. While logic 530 is illustrated as a hardware component attached to bus 508, it is to be appreciated that in one example, logic 530 could be implemented in processor 502.

Generally describing an example configuration of computer 500, processor 502 may be a variety of various processors including dual microprocessor and other multi-processor architectures. Memory 504 may include volatile memory and/or non-volatile memory. Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), and direct RAM bus RAM (DRRAM).

Disk 506 may be operably connected to the computer 500 via, for example, an input/output interface (e.g., card, device) 518 and an input/output port 510. Disk 506 may be, for example, a magnetic disk drive, a solid state disk drive, a floppy disk drive, a tape drive, a Zip drive, a flash memory card, and/or a memory stick. Furthermore, disk 506 may be a CD-ROM, a CD recordable drive (CD-R drive), a CD rewriteable drive (CD-RW drive), and/or a digital video ROM drive (DVD ROM). Memory 504 can store processes 514 and/or data 516, for example. Disk 506 and/or memory 504 can store an operating system that controls and allocates resources of computer 500.

Bus 508 may be a single internal bus interconnect architecture and/or other bus or mesh architectures. While a single bus is illustrated, it is to be appreciated that computer 500 may communicate with various devices, logics, and peripherals using other busses (e.g., PCIE, SATA, Infiniband, 1394, USB, Ethernet). Bus 508 can be types including, for example, a memory bus, a memory controller, a peripheral bus, an external bus, a crossbar switch, and/or a local bus. The local bus may be, for example, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

Computer 500 may interact with input/output devices via i/o interfaces 518 and input/output ports 510. Input/output devices may be, for example, a keyboard, a microphone, a pointing and selection device, cameras, video cards, displays, disk 506, network devices 520, and so on. Input/output ports 510 may include, for example, serial ports, parallel ports, and USB ports.

Computer 500 can operate in a network environment and thus may be connected to network devices 520 via i/o devices 518, and/or i/o ports 510. Through the network devices 520, computer 500 may interact with a network. Through the network, computer 500 may be logically connected to remote computers. Networks with which computer 500 may interact include, but are not limited to, a local area network (LAN), a wide area network (WAN), and other networks. In different examples, network devices 520 may connect to LAN technologies including, for example, fiber distributed data interface (FDDI), copper distributed data interface (CDDI), Ethernet (IEEE 802.3), token ring (IEEE 802.5), wireless computer communication (IEEE 802.11), and Bluetooth (IEEE 802.15.1). Similarly, network devices 520 may connect to WAN technologies including, for example, point to point links, circuit switching networks (e.g., integrated services digital networks (ISDN)), packet switching networks, and digital subscriber lines (DSL).

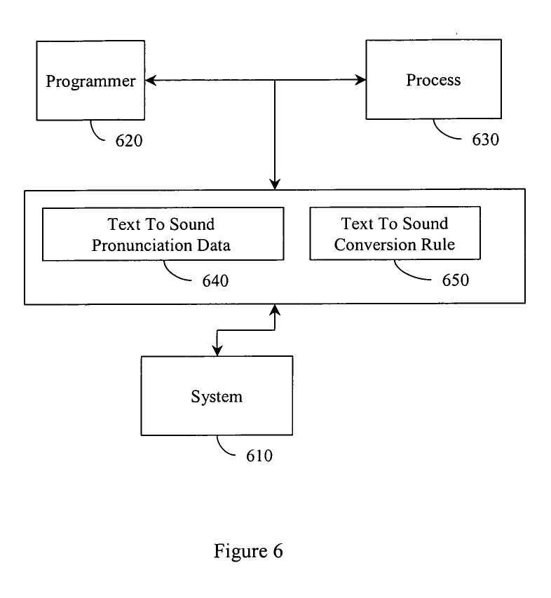

FIG. 6 illustrates an application programming interface (API) 600 that provides access to a system 610 for word matching with context sensitive character to sound correlating. API 600 can be employed, for example, by a programmer 620 and/or a process 630 to gain access to processing performed by system 610. For example, programmer 620 can write a program to access system 610 (e.g., invoke its operation, monitor its operation, control its operation) where writing the program is facilitated by the presence of API 600. Rather than programmer 620 having to understand the internals of system 610, programmer 620 merely has to learn the interface to system 610. This facilitates encapsulating the functionality of system 610 while exposing that functionality.

In one example, an API 600 can be stored on a computer-readable medium. Interfaces in API 600 can include, but are not limited to, a first interface 640 that communicates a text to sound pronunciation data and a second interface 650 that communicates a text to sound conversion rule that is based, at least in part, on text to sound pronunciation data. The text to sound pronunciation data may include, for example, phoneme based code representations for individual characters. Text to sound conversion rules may include, for example, alignment based grapheme to phoneme rules organized in a data structure (e.g., decision tree).

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. The term “and/or” is used in the same manner, meaning “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A method, comprising:
automatically generating one or more context sensitive character to sound correlation rules;
providing the one or more rules to a query processing logic;
converting a word into a first set of sounds using the one or more rules; and
storing the word and first set of sounds in a data store searchable by the query processing logic.

2. The method of claim 1, including:
accepting a query term to match on pronunciation;
converting the query term into a second set of sounds using the one or more rules;
accessing the data store; and
controlling the query processing logic to select one or more words from the data store based, at least in part, on matching the second set of sounds to one or more first set of sounds.

3. The method of claim 1, where automatically generating the one or more rules includes machine learning the rules using one or more culturally aware pronunciation dictionaries during training, the culturally aware pronunciation dictionaries including words having characters described in a phonetically characterized training set of characters.

4. The method of claim 3, including creating a character specific training table for a character in the training set of characters, the character specific training table including one or more words in which the character is found, one or more grams for the character, and one or more sounds associated with the character, the character specific training table including one or more entries containing a related word, gram, and sound.

5. The method of claim 1, the one or more rules being configured to favor recall over precision.

6. The method of claim 1, including modifying an existing document classifying logic to automatically generate the one or more rules, where modifying an existing document classifying logic includes replacing a document classification definition used by the existing document classifying logic with a word classification definition, replacing a document category used by the existing document classifying logic with a sound that represents a character, and replacing one or more document tokens used by the existing document classifying logic by one or more grams for a character.

7. The method of claim 2, including controlling the query processing logic to input a string of grams associated with the query term and controlling the query processing logic to provide one or more possible sounds and one or more related confidences based on a context associated with the query term.

8. The method of claim 1, where automatically generating the one or more rules includes controlling a text-to-phoneme conversion logic to build grapheme-to-phoneme rules in the form of decision trees and providing as input to the text-to-phoneme conversion logic one or more pronunciation dictionaries, where the text-to-phoneme conversion logic relies on alignment where letters are matched with phonemes and a mapping is made between ordered lists of letters and phonemes.

9. The method of claim 8, including producing one or more feature vectors for a letter based, at least in part, on alignment, the feature vectors being configured to provide a context for the letter.

10. The method of claim 9, where the context includes a relationship to one or more of, a previous letter, and a following letter.

11. The method of claim 2, including controlling the query processing logic to select one or more words from the data store based, at least in part, on matching items, where matching items includes an orthographic match and a phonetic match, the orthographic match computing an edit distance between two items being compared, the phonetic match computing a linguistic edit distance between two items being compared, the orthographic match and the phonetic match being combined into a score upon which a match can be ranked.

12. The method of claim 2, including accepting one or more user inputs concerning one or more of, a maximum number of highest confidence sounds considered for a character, and a minimum confidence for a combination of character sounds.

13. The method of claim 2, including computing an overall confidence for a match for a word selected from the data store from one or more confidences related to letters in the word.

14. The method of claim 1, including accepting a user input to configure an index for use by the query processing logic, the user input concerning one or more of, selecting a field that includes word data to index, assigning a confidence weighting on a field, setting a confidence score for a possible field ordering, determining a phonetic sound representation of a word based on pronunciation training data, storing combinations of words and sounds, storing grams of combinations of words and sounds in inverted indexes, storing base table names, and storing meta-data.

15. The method of claim 2, including accepting a user input configured to manipulate a query for use by the query processing logic, the user input concerning one or more of, setting a threshold and discount factor, selecting a maximum number of results, selecting a minimum overall confidence threshold, adjusting an orthographic similarity weighting, adjusting a phonetic similarity weighting, adjusting an orthographic similarity confidence threshold, adjusting a phonetic similarity confidence threshold, assigning one or more confidence weightings to one or more fielded query terms, and establishing a region parameter associated with a region-specific pronunciation rewrite rule.

16. The method of claim 2, where the word converted into the first set of sounds using the one or more rules is a name and where the query term is a name.

17. The method of claim 2, the data store being configured as a relational database.

18. A computer-readable medium storing processor executable instructions operable to perform a method, the method comprising:
automatically generating one or more recall biased context sensitive character to sound correlation rules using one or more culturally aware pronunciation dictionaries during machine learning training, the culturally aware pronunciation dictionaries including words having characters described in a phonetically characterized training set of characters, where automatically generating the one or more rules includes controlling a text-to-phoneme conversion logic to build grapheme-to-phoneme rules in the form of decision trees and includes providing as input to the text-to-phoneme conversion logic one or more pronunciation dictionaries, where the text-to-phoneme conversion logic relies on alignment where letters are matched with phonemes and a mapping is made between ordered lists of letters and phonemes;
creating a character specific training table for a character in the training set of characters, the character specific training table including one or more words in which the character is found, one or more grams for the character, and one or more sounds associated with the character, the character specific training table including one or more entries containing related words, grams, and sounds;
producing one or more feature vectors for a letter based, at least in part, on alignment, the feature vectors being configured to provide a context for the letter, where the context includes a relationship to one or more of, a previous letter, and a following letter;
providing the one or more rules to a query processing logic;
converting a word into a first set of sounds using the one or more rules;
storing the word and first set of sounds in a data store searchable by the query processing logic;
accepting a query term to match on pronunciation;
converting the query term into a second set of sounds using the one or more rules;
controlling the query processing logic to input a string of grams associated with the query term;
accessing the data store;
controlling the query processing logic to select one or more words from the data store based, at least in part, on matching the second set of sounds to one or more first set of sounds;
controlling the query processing logic to provide one or more confidences related to the one or more words; and
computing an overall confidence for a match for a word selected from the data store from confidences related to the letters in the word.

19. A system, comprising:
one or more data stores configured to store one or more text to sound pronunciation data entries, one or more text training words, one or more text to sound conversion rules, and one or more text and sound representation data entries; and
a machine learning logic configured to automatically generate one or more text to sound conversion rules from the text to sound pronunciation data entries and the text training words, to store the text to sound conversion rules, to automatically generate one or more text and sound representation data entries, and to store the one or more text and sound representation data entries.

20. The system of claim 19, including a query processing logic configured to receive a textual representation of a word, to produce a sound representation of the word using one or more of the text to sound conversion rules, and to provide one or more elements of one or more text and sound representation data entries based, at least in part, on matching sounds associated with the word to sounds associated with sound representation data stored in the text and sound representation data entries.

21. The system of claim 20, the query processing logic being configured to favor recall over precision.

22. The system of claim 20, text to sound pronunciation data entries including an ordered list of letters and phonemes, text to sound conversion rules being alignment based grapheme to phoneme rules organized in a decision tree, text and sound representation data entries including one or more context providing feature vectors for a letter in a word; and
the machine learning logic being configured to create character specific training tables for characters in the text training words, character specific training tables including one or more words in which a character is found, one or more grams for a character, and one or more sounds associated with a character, a character specific training table including one or more related sets of data containing a related word, gram, and sound.

23. The system of claim 22, including an index manipulation logic configured to perform one or more of, selecting a field that includes word data to index, assigning a confidence weighting on a field, setting a confidence score for a possible field ordering, determining a phonetic sound representation of a word based on pronunciation training data, storing combinations of words and sounds, storing grams of combinations of words and sounds in inverted indexes, storing base table names, and storing meta-data; and
a query manipulation logic configured to manipulate a query for use by the query processing logic, the manipulating including one or more of, setting a threshold and discount factor, selecting a maximum number of results, selecting a minimum overall confidence threshold, adjusting an orthographic edit distance weighting, adjusting a phonetic edit distance weighting, adjusting an orthographic edit distance confidence threshold, adjusting a phonetic edit distance confidence threshold, assigning one or more confidence weightings to one or more query terms, and establishing a region parameter associated with a region-specific pronunciation rewrite rule.

24. A system, comprising:
means for computing a control data for selectively controlling a text to sound conversion logic;
means for computing a set of sounds from a word; and
means for matching a first set of sounds to a second set of sounds, the first set of sounds being computed from a first word and the second set of sounds being computed from a second word.

25. A set of application programming interfaces embodied on a computer-readable medium for execution by a computer component in conjunction with word matching with context sensitive character to sound correlating, comprising:
a first interface for communicating a text to sound pronunciation data; and
a second interface for communicating a text to sound conversion rule that is based, at least in part, on the text to sound pronunciation data.
